(19) United States
(12) Patent Application Publication
(10) Pub. No.: US 2011/0320061 A1
(43) Pub. Date: Dec. 29, 2011

(54) TEMPERATURE CONTROL SYSTEM AND METHOD FOR COMPUTING DEVICE

(75) Inventor: SHIH-CHIEH CHEN, Tu-Cheng (TW)

(73) Assignee: HON HAI PRECISION INDUSTRY CO., LTD., Tu-Cheng (TW)

(21) Appl. No.: 12/963,813

(22) Filed: Dec. 9, 2010

(30) Foreign Application Priority Data
Jun. 23, 2010 (TW) 99120538

(51) Int. Cl. G05D 23/19

(52) U.S. Cl. 700/300

(57) ABSTRACT

A temperature control system and method can automatically adjust temperature of a computing device whether the computing device is in a closed loop state or an open loop state. The computing device includes a central processing unit (CPU), and a temperature sensor and a fan coupled to the CPU. The temperature sensor senses a CPU temperature of the CPU and an environment temperature of the computing device. The method sets a standard temperature, a first logic temperature, and a second logic temperature, and obtains the CPU temperature sensed by the temperature sensor. The method determines whether the CPU temperature needs to be adjusted according to the standard temperature, the first logic temperature, and the second logic temperature, and controls a rotational speed of the fan and a frequency of the CPU to adjust the CPU temperature under different rotational modes of the fan.

### BACKGROUND

1. Technical Field

Embodiments of the present disclosure relate generally to temperature control systems and methods, and more particularly to a temperature control system and method for a computing device.

2. Description of related art

Computing devices may include a central processing unit (CPU), an electric fan located on the CPU, a memory device, or other components, which usually generate a lot of heat while working. Overheating of a computing device (such as a computer, for example) may lead to data loss or even damage to the computing device. Currently, temperature sensors and electric fans are coupled to the CPU for heat dispersion of the computing device. The temperature sensors measure the temperature of the computing device, while the electric fans are controlled to run at different rotational speeds. However, changes in work load of the computer cause changes in the temperature of the computing device frequently. With current temperature control systems and methods to control the temperature of the computing devices, the electric fans may make more noise as the CPU changes frequency.

### BRIEF DESCRIPTION OF THE DRAWINGS

FIG. 1 is a schematic diagram of one embodiment of a temperature control system for a computing device.

FIG. 2 is a schematic diagram illustrating one example of different rotational modes of a fan included in the computing device of FIG. 1.

FIG. 3 is a flowchart of one embodiment of a temperature control method for the computing device under a closed loop state.

FIG. 4 is a flowchart of one embodiment of a temperature control method for the computing device under an open loop state.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

As used herein, the term “closed loop state” is defined as a working state of a computing device that is not readily influenced by environmental conditions, such as temperature and humidity of the environment, for example. The term “open loop state” is defined as a working state of the computing device that is readily influenced by the environment conditions.

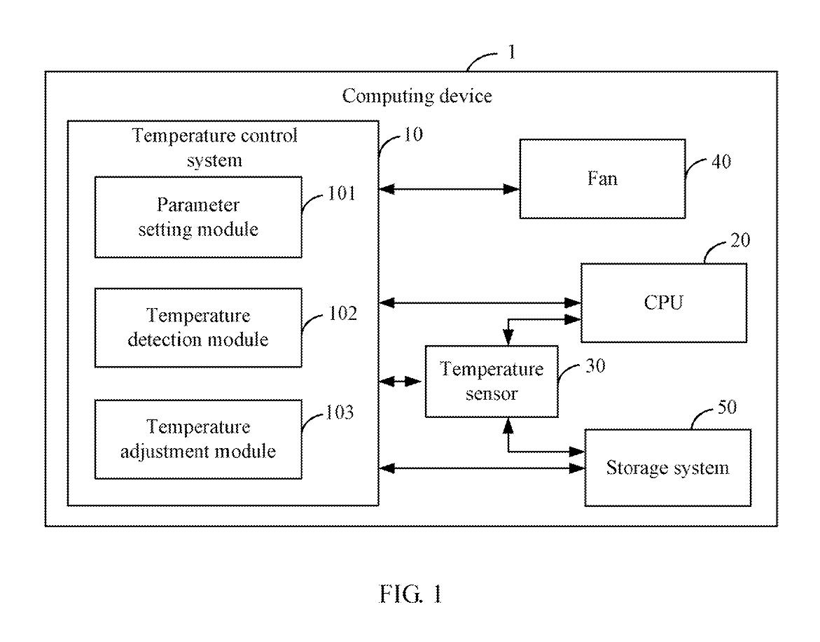

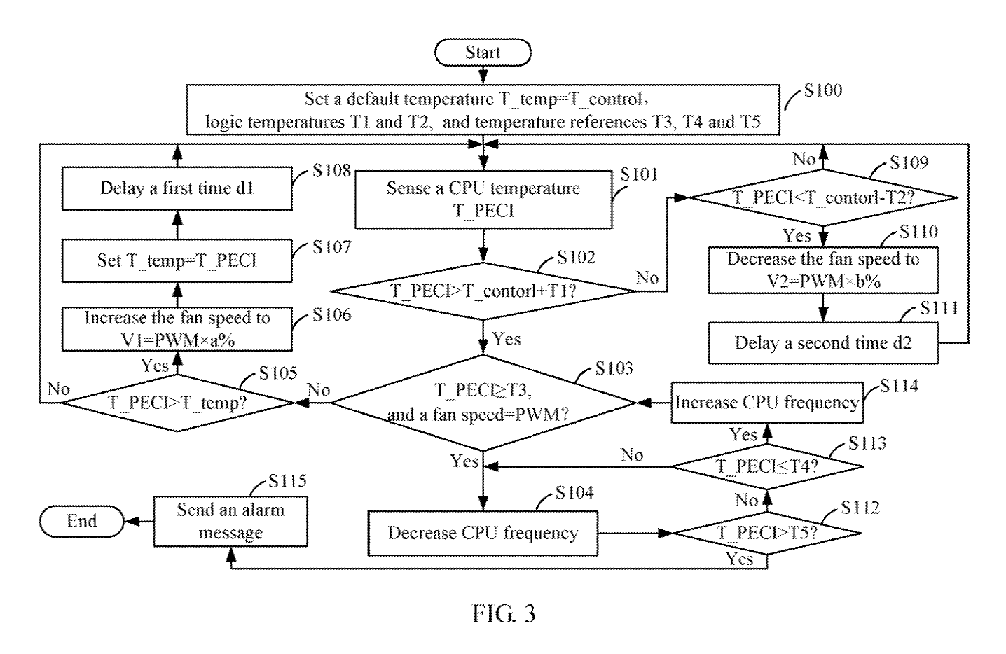

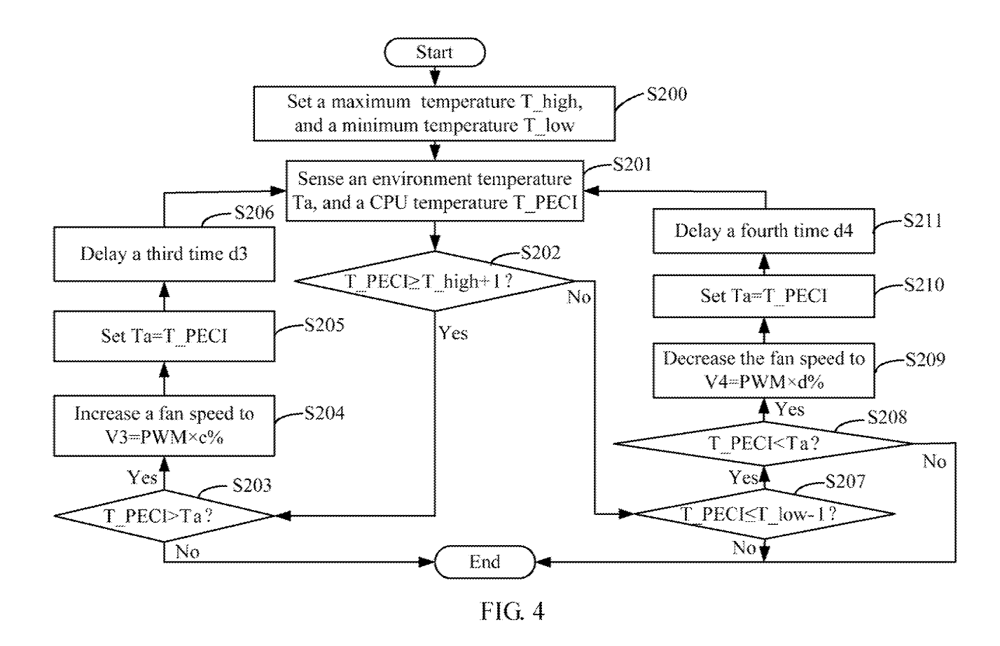

FIG. 1 is a schematic diagram of one embodiment of a temperature control system 10 for a computing device 1. In the embodiment, the temperature control system 10 is included in and run by the computing device 1, and can automatically control a system temperature of the computing device 1 under the closed loop state (shown in FIG. 3) and the open loop state (shown in FIG. 4).

The computing device 1 may further include a central processing unit (CPU) 20, a temperature sensor 30, an electric fan 40, and a storage system 50. It should be understood that FIG. 1 illustrates only one example of the computing device 1, and may include more or fewer components than illustrated, or a different configuration of the various components in other embodiments. In one embodiment, the computing device 1 may be a desktop computer, a notebook computer, a sever, a workstation, or any data processing device.

The temperature sensor 30 is coupled to the computing device 1 for sensing and measuring the temperature of the computing device 1, while the fan 40 is controlled to run at different rotational speeds. In one embodiment, the temperature sensor 30 senses a temperature of the CPU 20 (hereinafter “the CPU temperature”) and a temperature of the environment (hereinafter “the environment temperature”). The fan 40 is also coupled to the computing device 1 for heat dispersion of components, such as the CPU 20, or the storage system 50.

The temperature control system 10 may include a plurality of functional modules including one or more computerized instructions that are stored in the storage system 50 and executed by the CPU 20. In one embodiment, the storage system 50 may be an internal storage device, such as a random access memory (RAM) for temporary storage of information, and/or a read only memory (ROM) for permanent storage of information. In some embodiments, the storage system 50 may also be an external storage device, such as an external hard disk, a storage card, or a data storage medium.

In one embodiment, the temperature control system 10 includes a parameter setting module 101, a temperature detection module 102, and a temperature adjustment module 103. The modules 101-103 may comprise computerized code in the form of one or more programs that are stored in the storage system 11. The computerized code includes instructions that are executed by the CPU 20 to provide functions for modules 101-103. In general, the word “module,” as used herein, refers to logic embodied in hardware or firmware, or to a collection of application instructions, written in a programming language. The application instructions in the modules may be embedded in firmware, such as an erasable programmable read only memory (EPROM). The modules described herein may be implemented as either application and/or hardware modules and may be stored in any type of computer-readable medium or other storage device.

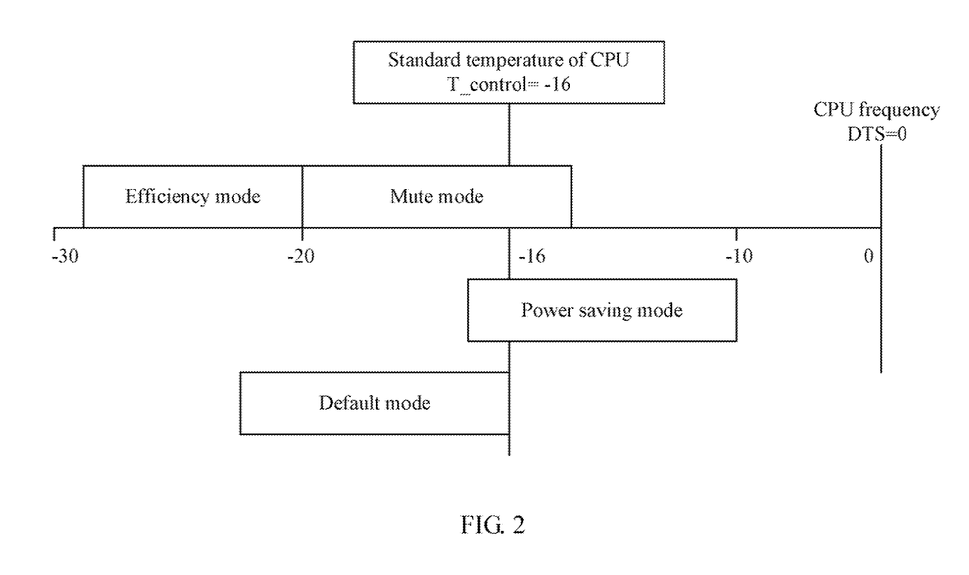

The parameter setting module 101 is operable to set a default temperature (denoted as T_temp) as a standard temperature (denoted as T_control) of the CPU 20, i.e., T_temp=T_control. The standard temperature T_control is usually defined by a manufacture according to a type of the CPU 20, such as the standard temperature of INTEL CPU is defined as T_control=−16, for example in FIG. 2. The parameter setting module 101 is further operable to set a first logic temperature T1, a second logic temperature T2, a first reference temperature T3, and a second reference temperature T4, and a third reference temperature T5, where T1<T2<T3<T4<T5. In addition, the parameter setting module 101 sets a temperature range of the environment temperature that can be defined as between a minimum temperature T_low and a maximum temperature T_high, such as T_low=-20° C., and T_high=60° C., for example.

The temperature detection module 102 is operable to obtain the CPU temperature and the environment temperature sensed by the temperature sensor 30. The temperature detection module 102 is further operable to determine whether the CPU temperature needs to be adjusted under the closed loop state of the computing device 1. In the embodiment, the CPU temperature is determined according to the standard temperature, the first logic temperature T1, and the second logic temperature T2. In addition, the temperature detection module 102 determines whether the CPU temperature is in the temperature range under the open loop state of the computing device 1.

The temperature adjustment module 103 is operable to control a rotational speed of the fan 40 and a frequency of the CPU 20 to adjust the CPU temperature under different rotational modes of the fan 40. In one embodiment, the rotational modes may include a default mode, an efficiency mode, an mute mode, and a power saving mode. The default mode is defined as a mode that the fan 40 rotates at a default rotational speed, such as 1800 RPM (rotation per minute). The efficiency mode is a mode that the fan 40 rotates at a rotational speed with high working performance The mute mode is defined as a mode that the fan 40 rotates at a rotational speed with fewer noises. The power saving mode is defined as a mode that the fan 40 rotates at a rotational speed with power save.

FIG. 2 is a schematic diagram illustrating one example of different rotational modes of the fan 40. As mentioned above, the standard temperature T_control, which is usually defined by a manufactory according to a type of the CPU 20. One example in the embodiment, the CPU 20 is made by INTEL, and the standard temperature is defined as T_control=−16. Assuming that a difference value of the CPU temperature is ΔT=T1-T2, where T1 represents the first logic temperature, and T2 represents the second logic temperature. If −25° C<ΔT<−16° C., the fan 40 rotates in the default mode. If −30° C<ΔT<−20° C., the fan 40 rotates in the efficiency mode. If −20° C<ΔT<−15° C., the fan 40 rotates in the mute mode. If −17° C<ΔT<−10° C., the fan 40 rotates in the power saving mode.

FIG. 3 is a flowchart of one embodiment of a temperature control method for the computing device 1 under the closed loop state. Depending on the embodiment, additional blocks may be added, others removed, and the ordering of the blocks may be changed.

In block S100, the parameter setting module 101 sets a default temperature (denoted as T_temp), and sets the default temperature T_temp as a standard temperature (denoted as T_control), i.e., T_temp=T control. The parameter setting module 101 further sets a first logic temperature T1, a second logic temperature T2, a first reference temperature T3, a second reference temperature T4, and a third reference temperature T5, where T1<T2<T3<T4<T5. In one embodiment, the first logic temperature T1 can be set as “0”, and the second logic temperature T2 can set as “8”, then T3=T_control+5, T4=T_control+8, and T5=T_control+10.

In block S101, the temperature detection module 102 obtains a current temperature of the CPU 20 (hereinafter “CPU temperature” denoted as T_PECI) sensed by the temperature sensor 30. In the embodiment, the temperature sensor 30 senses the CPU temperature T_PECI from the CPU 20 when the computing device 1 works in the closed loop state.

In block S102, the temperature detection module 102 determines whether the CPU temperature T_PECI is greater than a sum of the standard temperature T_control and the first logic temperature T1, i.e., T_PECI>T_control+T1. If the CPU temperature T_PECI is greater than the sum, block S103 is implemented. Otherwise, if the CPU temperature T_PECI is not greater than the sum, bock S109 is implemented.

In block S103, the temperature detection module 102 determines whether the CPU temperature T_PECI is greater than the first reference temperature T3 and a fan speed (denoted as “V0”) is in a full speed of pulse-width modulation (100%*PWM), i.e., T_PECI>=T3 and V0=100%*PWM. If T_PECI>=T3 and V0=100%*PWM, block S104 is implemented. Otherwise, if T_PECI<T3 and V0<100%*PWM, block S105 is implemented.

In block S104, the temperature adjustment module 103 decreases the CPU frequency (denoted as F0) as a first frequency (denoted as F1). In one embodiment, if the CPU temperature T_PECI is greater than the first reference temperature T3, the first frequency F1 is decreased as F1=F0*30%. If the CPU temperature T_PECI is greater than the second reference temperature T4, the first frequency F1 is decreased as F1=F0*70%. If the CPU temperature T_PECI is greater than the third reference temperature T5, the first frequency F1 is decreased as F1=0, thereby the computing device 1 needs to be powered off.

In block S105, the temperature detection module 102 determines whether the CPU temperature T_PECI is greater than the default temperature T_temp, i.e., T_PECI>T_temp. If the CPU temperature T_PECI is greater than the default temperature T_temp, block S106 is implemented. Otherwise, if the CPU temperature T_PECI is not greater than the default temperature T_temp, block S101 is repeated.

In block S106, the temperature adjustment module 103 increases the fan speed as a first rotational speed (denoted as V1), i.e., V1=PWM*a%, where “a” represents a number range that is among the number 0 from the number 1.

In block S107, the parameter setting module 101 sets the default temperature T_temp as the CPU temperature T_PECI, i.e., T_temp=T_PECI. In block S108, the temperature detection module 102 delays a first time (denoted as d1), such as d1=1 minute, and then obtains the CPU temperature T_PECI sensed by the temperature sensor 30 while the fan 40 rotates at the first rotational speed V1, i.e., block S101 is repeated.

In block S109, the temperature detection module 102 determines whether the CPU temperature T_PECI is less than a difference between the standard temperature T_control and the second logic temperature T2, i.e., T_PECI<T_control−T2. If the CPU temperature T_PECI is less than the difference, block S110 is implemented. Otherwise, if the CPU temperature T_PECI is not less than the difference, block S101 is repeated.

In block S110, the temperature adjustment module 103 decreases the fan speed as a second rotational speed (denoted as V2), i.e., V2=PWM*b%, where “b” represents a number range that is among the number 0 from the number 1.

In block S111, the temperature detection module 102 delays a second time (denoted as d2), such as d2=2 minutes, and then obtains the CPU temperature T_PECI sensed by the temperature sensor 30 while the fan 40 rotates at the second rotational speed V2, i.e., block S101 is repeated.

In block S112, the temperature detection module 102 determines whether the CPU temperature T_PECI is greater than the third reference temperature T5, i.e., T_PECI>T5. If the CPU temperature T_PECI is greater than the third reference temperature T5, block S115 is implemented. Otherwise, if the CPU temperature T_PECI is not greater than the third reference temperature T5, block S113 is implemented.

In block S113, the temperature detection module 102 determines whether the CPU temperature T_PECI is less than or equal to the second reference temperature T4, i.e., T_PECI<=T4. If the CPU temperature T_PECI is less than or equal to the second reference temperature T4, block S114 is implemented. Otherwise, if the CPU temperature T_PECI is .greater than the second reference temperature T4, block S104 is repeated.

In block S114, the temperature adjustment module 103 increases the CPU frequency FO as a second frequency (denoted as F2), i.e., F2=F0+F0*n, where n represents a number range that is among the number 0 from the number 1.

In block S115, the temperature adjustment module 103 generates an alarm message when the CPU temperature T_PECI is greater than the third reference temperature T5, to inform a user that the computing device 1 needs to be powered off.

FIG. 4 is a flowchart of one embodiment of a temperature control method for the computing device 1 under the open loop state. Depending on the embodiment, additional blocks may be added, others removed, and the ordering of the blocks may be changed.

In block S200, the parameter setting module 101 sets a temperature range of a environment temperature (denoted as Ta) of the computing device 1. The temperature range is between a minimum temperature T_low and a maximum temperature T_high, such as T_low=−20° C., and T_high=60° C., for example.

In block S201, the temperature detection module 102 obtains the environment temperature Ta and the CPU temperature T_PECI sensed by the temperature sensor 30. In the embodiment, the temperature sensor 30 senses the CPU temperature T_PECI from the CPU 20 and the environment temperature Ta of the computing device 1 when the computing device 1 works in the open loop state.

In block S202, the temperature detection module 102 determines whether the CPU temperature T_PECI is greater than or equal to a sum of the maximum temperature T_high and 1, i.e., T_PECI>=T_high+1. If the CPU temperature T_PECI is greater than or equal to the sum, block S203 is implemented. Otherwise, if the CPU temperature T_PECI is less than the sum, block S207 is implemented.

In block S203, the temperature detection module 102 determines whether the CPU temperature T_PECI is greater than the environment temperature Ta, i.e., T_PECI>Ta. If the CPU temperature T_PECI is greater than the environment temperature Ta, block S204 is implemented. If the CPU temperature T_PECI is not greater than the environment temperature Ta, the flow ends.

In block S204, the temperature adjustment module 103 increases the fan speed as a third rotational speed (denoted as V3), i.e., V3=PWM*c%, where “c” represents a number range that is among the number 0 from the number 1.

In block S205, the parameter setting module 101 sets the environment temperature Ta as the CPU temperature T_PECI, i.e., Ta=T_PECI. In block S206, the temperature detection module 102 delays a third time (denoted as d3), such as d3=3 minutes, and then obtains the CPU temperature T_PECI and the environment temperature Ta sensed by the temperature sensor 30 while the fan 40 rotates at the third rotational speed V3, i.e., block S201 is repeated.

In block S207, the temperature detection module 102 determines the CPU temperature T_PECI is less than or equal to a difference between the minimum temperature T_low and 1, i.e., T_PECI<=T_low−1. If the CPU temperature T_PECI is less than or equal to the difference, block S208 is implemented. If the CPU temperature T_PECI is greater than the difference, the flow ends.

In block S208, the temperature detection module 102 determines whether the CPU temperature T_PECI is less than the environment temperature Ta, i.e., T_PECI<Ta. If the CPU temperature T_PECI is less than the environment temperature Ta, block S209 is implemented. If the CPU temperature T_PECI is not less than the environment temperature Ta, the flow ends.

In block S209, the temperature adjustment module 103 increases the fan speed as a fourth rotational speed (denoted as V4), i.e., V4=PWM*d%, where “d” represents a number range that is among the number 0 from the number 1.

In block S210, the parameter setting module 101 sets the environment temperature Ta as the CPU temperature T_PECI, i.e., Ta=T_PECI. In block S211, the temperature detection module 102 delays a fourth time (denoted as d4), such as d4=4 minutes, and then obtains the CPU temperature T_PECI and the environment temperature Ta sensed by the temperature sensor 30 while the fan 40 rotates at the fourth rotational speed V4, i.e., block S201 is repeated.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system, a central processing unit (CPU), and a fan coupled to the CPU;
a temperature sensor operable to sense a CPU temperature of the CPU, and an environment temperature of the computing device;
one or more programs that are stored in the storage system and are executed by the CPU, the one or more programs comprising:
a parameter setting module operable to set a standard temperature, a first logic temperature, a second logic temperature, a first reference temperature, a second reference temperature, and a third reference temperature;
a temperature detection module operable to obtain the CPU temperature sensed by the temperature sensor, and determine whether the CPU temperature needs to be adjusted according to the standard temperature, the first logic temperature, and the second logic temperature; and
a temperature adjustment module operable to control a rotational speed of the fan and a frequency of the CPU to adjust the CPU temperature according to the first reference temperature, the second reference temperature, and the third reference temperature.

2. The computing device according to claim 1, wherein the parameter setting module is further operable to set a temperature range of the environment temperature.

3. The computing device according to claim 2, wherein the temperature detection module is further operable to determine whether the CPU temperature is within the temperature range, increase the rotational speed of the fan when the CPU temperature is greater than a maximum temperature of the environment temperature, and decrease the rotational speed of the fan when the CPU temperature is less than a minimum temperature of the environment temperature.

4. The computing device according to claim 1, wherein the temperature adjustment module is further operable to generate an alarm message when the CPU temperature is greater than the third reference temperature.

5. The computing device according to claim 1, wherein the fan rotates in a rotational mode that is a default mode, an efficiency mode, a mute mode, or a power saving mode.

6. The computing device according to claim 1, wherein the standard temperature is defined by a manufactory according to a type of the CPU.

7. A temperature control method for a computing device, the computing device comprising a central processing unit (CPU), a temperature sensor and a fan, the temperature sensor and the fan being coupled to the CPU, the method comprising:
setting a standard temperature, a first logic temperature, a second logic temperature, a first reference temperature, a second reference temperature, and a third reference temperature;
obtaining a CPU temperature sensed by the temperature sensor;
determining whether the CPU temperature needs to be adjusted according to the standard temperature, the first logic temperature, and the second logic temperature;
comparing the CPU temperature with the first reference temperature, the second reference temperature, and the third reference temperature upon the condition that the CPU temperature needs to be adjusted;
increasing a frequency of the CPU and a rotational speed of the fan to adjust the CPU temperature if the CPU temperature is between the first reference temperature and the second reference temperature; and
decreasing the frequency of the CPU and the rotational speed of the fan to adjust the CPU temperature if the CPU temperature is between the second reference temperature and the third reference temperature.

8. The method according to claim 7, further comprising:
sensing an environment temperature of the computing device using the temperature sensor;
setting a temperature range of the environment temperature;
determining whether the CPU temperature is within the temperature range; and
controlling the rotational speed of the fan to adjust the CPU temperature upon the condition that the CPU temperature is not within the temperature range.

9. The method according to claim 8, wherein the controlling bock comprises:
increasing the rotational speed of the fan when the CPU temperature is greater than a maximum temperature of the environment temperature; and
decreasing the rotational speed of the fan when the CPU temperature is less than a minimum temperature of the environment temperature.

10. The method according to claim 7, further comprising:
generating an alarm message when the CPU temperature is greater than the third reference temperature.

11. The method according to claim 7, wherein the fan rotates in a rotational mode that is a default mode, an efficiency mode, a mute mode, or a power saving mode.

12. The method according to claim 7, wherein the standard temperature is defined by a manufactory according to a type of the CPU.

13. A storage medium having stored thereon instructions that, when executed by a central processing unit (CPU) of a computing device, causes the computing device to perform a temperature control method, the computing device comprising a temperature sensor and a fan coupled to the CPU, the method comprising:
setting a standard temperature, a first logic temperature, a second logic temperature, a first reference temperature, a second reference temperature, and a third reference temperature;
obtaining a CPU temperature sensed by the temperature sensor;
determining whether the CPU temperature needs to be adjusted according to the standard temperature, the first logic temperature, and the second logic temperature;
comparing the CPU temperature with the first reference temperature, the second reference temperature, and the third reference temperature upon the condition that the CPU temperature needs to be adjusted;
increasing a frequency of the CPU and a rotational speed of the fan to adjust the CPU temperature if the CPU temperature is between the first reference temperature and the second reference temperature; and
decreasing the frequency of the CPU and the rotational speed of the fan to adjust the CPU temperature if the CPU temperature is between the second reference temperature and the third reference temperature.

14. The storage medium according to claim 13, wherein the method further comprises:
sensing an environment temperature of the computing device using the temperature sensor;
setting a temperature range of the environment temperature of the computing device;
determining whether the CPU temperature is within the temperature range; and
controlling the rotational speed of the fan to adjust the CPU temperature upon the condition that the CPU temperature is not within the temperature range.

15. The storage medium according to claim 14, wherein the controlling step comprises:
increasing the rotational speed of the fan when the CPU temperature is greater than a maximum temperature of the environment temperature; and
decreasing the rotational speed of the fan when the CPU temperature is less than a minimum temperature of the environment temperature.

16. The storage medium according to claim 13, wherein the method further comprises:
generating an alarm message when the CPU temperature is greater than the third reference temperature.

17. The storage medium according to claim 13, wherein the fan rotates in a rotational mode that is a default mode, an efficiency mode, a mute mode, or a power saving mode.

18. The storage medium according to claim 13, wherein the standard temperature is defined by a manufactory according to a type of the CPU.
